(19) United States
(12) Patent Application Publication
(10) Pub. No.: US 2008/0093901 A1
(43) Pub. Date: Apr. 24, 2008

(54) Headrest cover

(75) Inventors: Joy Hodge, Darby, PA (US); Ethan Daniel Civan, Blue Bell, PA (US)

Correspondence Address: ETHAN D. CIVAN, 170 SOMERSET DRIVE, BLUE BELL, PA, 19422, US

(73) Assignee: Joy Hodge

(21) Appl. No.: 11/583,337

(22) Filed: Oct. 19, 2006

(51) Int. Cl. A61G 15/00

(52) U.S. Cl. 297/220

(57) ABSTRACT

A vehicle headrest, including a plurality of panel members and at least one closure, wherein at least one of the plurality of panel members includes a decorative motif.

### FIELD OF THE INVENTION

The present invention relates to vehicle headrests.

### BACKGROUND

Vehicle headrests are generally non-descript and do not express the personality of the owners of the vehicles in which they are located. It would be desirable to allow drivers of vehicles, such as automobiles, to utilize headrest covers to personalize the decor of their vehicles. Moreover, many drivers possess oily hair or utilize hair products that leave residues on vehicle headrests. It would therefore be desirable to allow drivers of vehicles to utilize removable headrest covers capable of protecting the vehicle headrests.

### SUMMARY OF THE INVENTION

A vehicle headrest, including a plurality of panel members and at least one closure, wherein at least one of the plurality of panel members includes a decorative motif.

### BRIEF DESCRIPTION OF THE DRAWINGS

FIG. 1A is an illustration of a first embodiment of the present invention.

FIG. 1B is a second illustration of an alternate embodiment of the present invention.

FIG. 2A is an illustration of a vehicle headrest.

FIG. 2B is an illustration of a first embodiment of the present invention used on a vehicle headrest.

FIG. 3 is an illustration of a third embodiment of the present invention used on a vehicle headrest.

### DETAILED DESCRIPTION OF THE PREFERRED EMBODIMENTS

The following definitions are provided to aid in construing the claims of the present application:

Decorative Motif: Any visual design, including but not limited to a visual design incorporating one or more of purely decorative elements, one or more insignias, one or more phrases or slogans, and one or more representations of real world items, including but not limited to a picture of the owner of the vehicle headrest cover.

Vehicle: Any vehicle, including, but not limited to, cars, trucks, buses, motorcycles, motorcycle sidecars, and personal motorized vehicles.

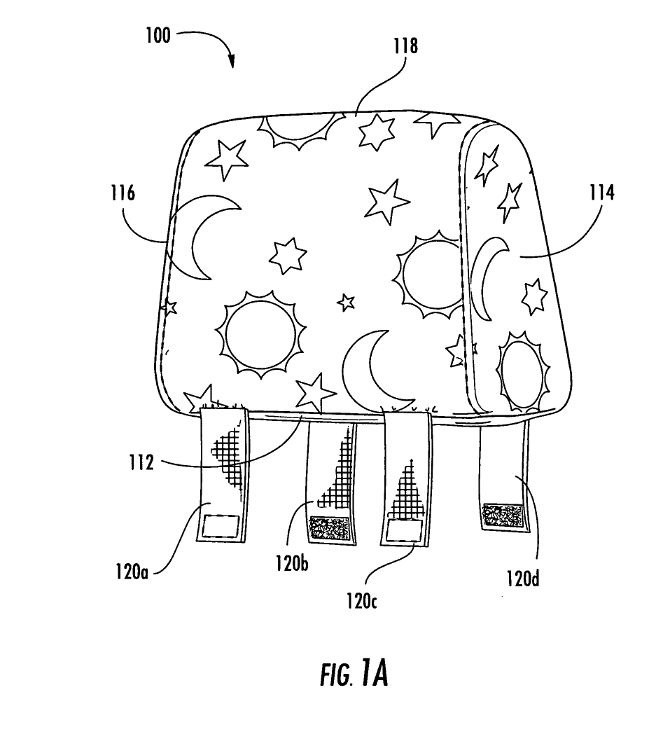

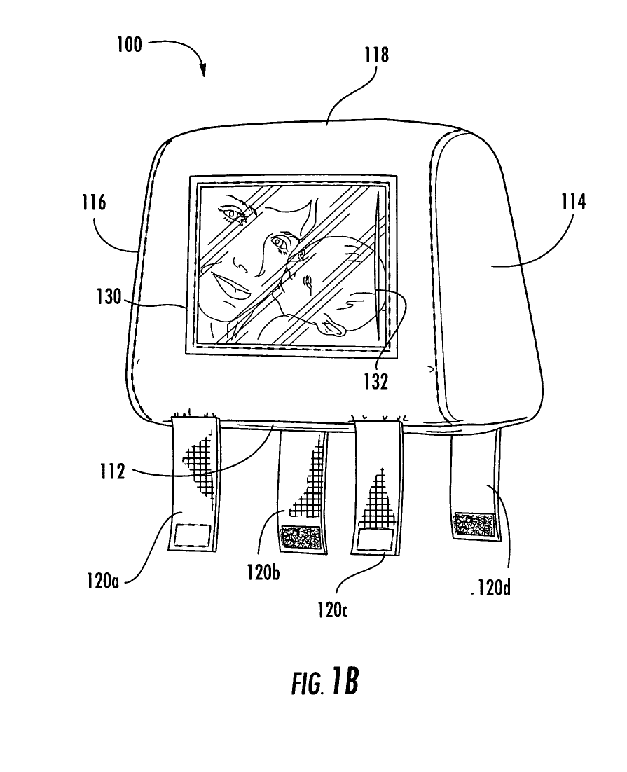

Referring to FIG. 1A, in a first preferred embodiment, vehicle headrest cover 100 includes front panel member 110 (not illustrated), rear panel member 112, side panel members 114 and 116, top panel member 118, and closures 120a through 120d. Front panel member 110, rear panel member 112, side panel members 114 and 116, and top panel member 118 can be made of cotton, wool, silk, leather, velvet, linen, satin, lycra, or synthetic cloth or any other soft material capable of being formed into a cover for a headrest. Front panel member 110, rear panel member 112, side panel members 114 and 116, and top panel member 118 are connected together, for example, by being sewn or glued together or joined together by a Velcro closure or snapped or zippered together so as to form a shape generally corresponding to the shape of the headrest to be covered, but without a bottom panel in the first embodiment. In some embodiments of the present invention, a greater or lesser number of panels can be used; in fact, a single panel with a shape generally corresponding to the shape of the headrest to be covered can be used in some embodiments. In some embodiments, a bottom panel, having at least one hole in it, attached to one or more of the side panels and detachably attached to one or more of the other side panels is also present. In embodiments designed for vehicles with DVD screens on the back of front seats, it can be necessary to include a cutout in the back of the headrest cover to avoid obscuring the DVD screen. Similarly, other vehicles can require similar adaptations to the headrest cover, as will be obvious to those skilled in the art.

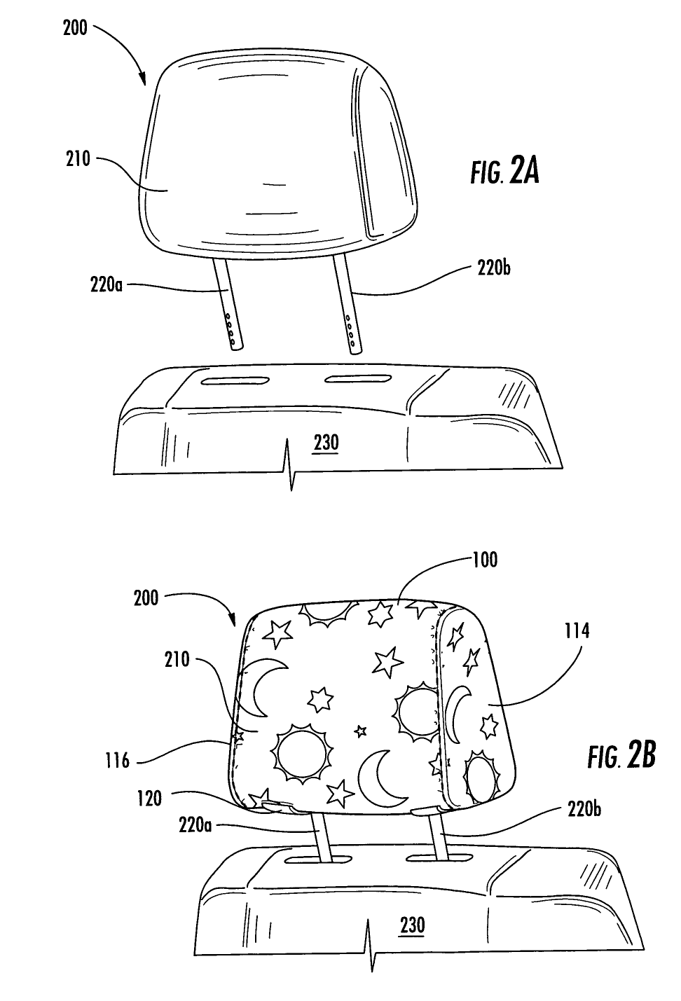

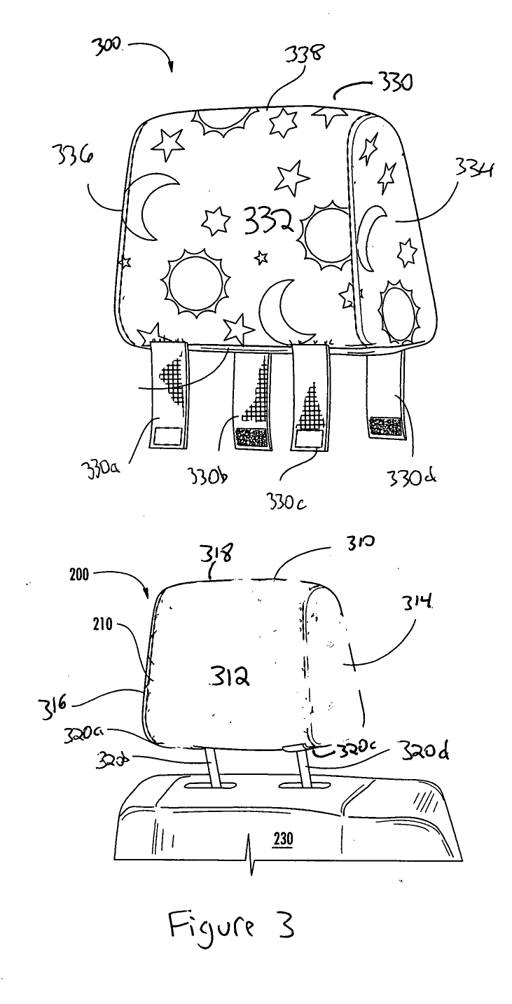

Closures 120a through 120d can comprise additional members of the same material as the panel members. Alternatively, other materials can be used or no members at all need be used in some embodiments. The additional members can then be closed underneath the bottom of the headrest when vehicle headrest cover 100 is on it as illustrated with respect to FIGS. 2A and 2B. Closures 120a through 120d can comprise Velcro closures, tie closures, snaps, buckles, clasps, zippers, hooks, buttons, drawstrings, or other closures. In other embodiments, closures 1 20a through 1 20d can be located in other locations that those shown in FIG. 1, such as on the sides or on the top of the headrest cover, rather than on the bottom of the headrest cover. In some embodiments, a greater or lesser number of closures can be utilized. For example, a single closure, such as a cord or strap wrapping around part or all of the headrest cover one or more times can be utilized. In yet other embodiments, closures can be omitted completely.

In some embodiments of the present invention, headrest cover 100 is reversible. This allows two decorative motifs to be used (one on each side). Moreover, it allows extended use before cleaning of headrest cover 100 is necessary. Preferably, headrest cover 100 is removable and washable. Because many drivers either possess oily hair or use hair products that tend to leave residues, it is desirable to clean headrest cover 100 periodically. In some embodiments, absorbent fabric, such as cotton or terrycloth, is used to absorb sweat and liquids from a user who is sweating from a recent workout (or other causes). Headrest cover 100 then provides the added benefit of protecting the headrest itself from accumulating residues. In other embodiments waterproof material can be utilized. In some embodiments, headrest cover 100 is custom fit to the size of the headrest in each particular car model to ensure a perfect fit and minimum slippage; in other embodiments, several standard sizes are utilized to reduce production costs.

One or more of the panel members in the preferred embodiments include a decorative motif. The decorative motif can consist of or be based, for example, on the insignia of a National Football League team, National Basketball League team, Major League baseball team, National Hockey League team, or other professional sports team (or on the insignias of the leagues themselves), an NCAA team, the Olympics, a military motif or a military unit's insignia, a college's coat of arms or colors, a sports motif, such as marathon runners, tennis, or golf, a religious motif, an African motif, a flag, a slogan, or a purely decorative motif chosen for its esthetic qualities. The decorative motif can also consist of or include a slogan or phrase, such as “God Bless America”, “Click it or Ticket”, “Knowledge is Power”, “God is Good all the Time”, “Jesus I Trust in You”, “World's Best Mom”, “World's Best Dad”, “No Fear”, “We are #1”, “Live Richly”, “PEACE”, “GOTTALOVEIT”, “Drive Safely”, “Honor Society”, “Just Do It”, “No Pain No Gain”, “I Love My Grandma”, “I Love New York”, “Make the Most of Now”, “POWS”, “Stop Smoking”, “A Time for Greatness”, or any similar phrase or slogan. The decorative motif can also incorporate or consist of a representation of a real world object, including but not limited to a picture of a person, such as a reproduction of a photograph of the owner of the headrest cover, or a member of such person's family (such as a baby), or a friend of such person, or a famous person or a pet animal, or scenery. The decorative motif can similarly include a photograph or picture of a memorable event (such as a wedding or graduation). Such a photograph can be a digital image or can be a standard film image transferred by silk screening or other means. The decorative motif can also include pictorial or textual advertising materials. The decorative motif can also include symbols, including religious symbols, such as crosses, professional symbols, such as caduceuses, athletic symbols, such as footballs or tennis rackets, abstract symbols, such as hearts, peace symbols, male and female symbols, or smiley faces, and characters in foreign languages, such as Chinese and Japanese. The decorative motif can also include a signature. The decorative motif can also include words in foreign alphabets, such as arabic. It is intended to provide a wide variety of decorative motifs in order to allow vehicle drivers to express their individuality. The decorative motif can be displayed on one, several, or all of the panel members of headrest cover 100. In a first preferred embodiment, it is displayed on all of the panel members. The decorative motif can also include one or more hanging ornaments, such as peace symbols, letters (such as initials), crosses, musical notes, representations of animals, flowers, etc.

Optionally, in some embodiments, a photograph or other picture can be inserted into pouch 130 through slit 132 as illustrated in FIG. 1B. This photograph or other picture can constitute the entire decorative motif, alternatively, additional elements of the decorative motif can be visible around the photograph or other picture. Slit 132 can be located at the right edge of pouch 130 as illustrated in FIG. 1B, at the left edge of pouch 130, at the top of pouch 130, at the bottom of pouch 130, in the center of pouch 130, or elsewhere. Pouch 130 can include clear plastic through which the photograph or other picture can be seen by a user. In another embodiment, instead of a pouch, a photograph or other picture is stitched onto or otherwise attached to the headrest, or scanned onto a piece of material that is stitched onto or otherwise attached to the headrest.

Referring to FIG. 2A, vehicle seat 200 includes headrest 210, headrest supports 220a and 220b, and seat back 230. Referring to FIG. 2B, headrest cover 100 is attached by sliding it over headrest 210 and fastening closures 120a through 120d as illustrated in FIG. 2B.

Referring to FIG. 3, a third preferred embodiment of the present invention is illustrated. Vehicle headrest 300 includes interior front panel member 310 (not illustrated), interior rear panel member 312, interior side panel members 314 and 316, interior top panel member 318, and interior closures 320a through 320d. These elements correspond to front panel member 110, rear panel member 112, side panel members 114 and 116, top panel member 118, and closures 120a through 120d in the first preferred embodiment described in connection with FIG. 1A except that no decorative motif need be displayed on any interior panel member.

In addition, vehicle headrest 300 includes exterior front panel member 330, exterior rear panel member 332, exterior side panel members 334 and 336, exterior top panel member 338, and exterior closures 330a through 330d. The exterior panel members are attached to (and outside of) the interior panel members) using exterior closures 330a through 330d. These elements correspond to front panel member 110, rear panel member 112, side panel members 114 and 116, top panel member 118, and closures 120a through 120d in the first preferred embodiment described in connection with FIG. 1 except that the exterior panel members are removably attached to the interior panel members using exterior closures 330a through 330d. In some embodiments, for example, exterior closures 330a through 330d can be one or more press-down Velcro closures under one or more exterior panel members. In some embodiments the exterior panel members completely cover the interior panel members; in others they do not. For example, in some embodiments, exterior side panels 334 and 336 are omitted.

The second preferred embodiment allows a user to remove and exchange the exterior portion of the headrest cover containing the decorative motif at will without removing the interior portion of the headrest cover, which is securely attached to the headrest. This has several benefits. First, the interior portion can be customized to fit a particular model vehicle snugly and securely, while the exterior portion can be a generic size cover, which fits somewhat loosely. This allows a broad range of decorative motifs to be offered corresponding to a large number of vehicles, without the need to offer every combination of vehicle and decorative motif. Second, the exterior portion can be removed easily for cleaning. Third, the user can easily change decorative motifs and therefore is motivated to accumulate multiple exterior covers.

In yet another embodiment hereunder (not illustrated), all of the front, rear, and side panels can be constructed of a single piece of material that can be slipped over the headrest. A drawstring or other closure can then be used to tighten or close the headrest cover about the headrest when it is in place. The headrest cover of this alternate embodiment can be decorated as described above with respect to the other embodiments of the present invention.

The present invention may be embodied in other specific forms without departing from the spirit or essential attributes of the invention. Accordingly, reference should be made to the appended claims, rather than the foregoing specification, as indicating the scope of the invention.

1. A vehicle headrest cover, comprising:
a plurality of panel members; and
at least one closure,
wherein all of said plurality of panel members includes a decorative motif.

2. (canceled)

3. The vehicle headrest cover of claim 1, wherein the closure comprises additional members attached to at least one of said plurality of panel members; and
wherein said additional members pass underneath a vehicle headrest when the vehicle headrest cover is closed upon the vehicle headrest.

4. The vehicle headrest cover of claim 1, wherein the closure comprises one of a clasp, a buckle, a zipper, a hook and loop fastener, a snap, and a tie closure.

5. The vehicle headrest cover of claim 1, wherein the decorative motif is a sports motif.

6. The vehicle headrest cover of claim 5, wherein the decorative motif relates to one of a National Football League, National Basketball League, Major League baseball, or National Hockey League team.

7. The vehicle headrest cover of claim 5, wherein the decorative motif relates to an NCAA team.

8. The vehicle headrest cover of claim 1, wherein the decorative motif relates to a religious theme.

9. The vehicle headrest cover of claim 1, wherein the decorative motif relates to a military theme.

10. The vehicle headrest cover of claim 1, wherein the decorative motif relates to an African theme.

11. The vehicle headrest cover of claim 1, wherein the decorative motif relates to an attractive pattern.

12. The vehicle headrest cover of claim 1, wherein the decorative motif relates to a symbol.

13. The vehicle headrest cover of claim 1, wherein the vehicle headrest is sized to fit a headrest found in a particular model of vehicle.

14. The vehicle headrest cover of claim 1, wherein the vehicle headrest is a standard size.

15. The vehicle headrest cover of claim 1, wherein the vehicle headrest is reversible.

16. (canceled)

17. A vehicle headrest cover, comprising:
at least one closure,
wherein at least one of said plurality of panel members includes a decorative motif; and
wherein the decorative motif includes one of a photograph or scanned digital image.

18. The vehicle headrest cover of claim 17, wherein the decorative motif includes a photograph attached to the vehicle headrest cover.

19. The vehicle headrest cover of claim 17, wherein the decorative motif includes a photograph imprinted onto the vehicle headrest cover by silk screening.

20. The vehicle headrest cover of claim 17, wherein the decorative motif includes a digital image printed on the vehicle headrest cover.

21. The vehicle headrest cover of claim 17, wherein the decorative motif includes a photograph inserted into a pouch attached to one of said plurality of panel members.
